(19) United States
(12) Patent Application Publication
(10) Pub. No.: US 2017/0081025 A1
(43) Pub. Date: Mar. 23, 2017

(54) METHODS AND APPARATUS FOR VERTICAL SHORT TAKEOFF AND LANDING AND OPERATIONAL CONTROL

(71) Applicant: THE HAYDEN EFFECT, LLC, Poway, CA (US)

(72) Inventor: Raymond Don Hayden, Poway, CA (US)

(21) Appl. No.: 15/179,859

(22) Filed: Jun. 10, 2016

Related U.S. Application Data
(60) Provisional application No. 62/174,417, filed on Jun. 11, 2015.

(51) Int. Cl. B64C 27/52; B64C 39/02; B64C 29/00

(52) U.S. Cl. CPC B64C 27/52; B64C 29/0033; B64C 39/024; B64C 2201/027; B64C 2201/108; B64C 2201/146

(57) ABSTRACT

Methods and apparatus for vertical or short takeoff and landing, and operational control during flight. In one embodiment, the apparatus comprises two or more counter driven rings with one or more airfoils attached. In one variant, there is an upper ring and a lower ring, each with multiple airfoils attached. In one variant, lift is generated largely via ambient air currents, allowing for long term on-station operation of the device. In another variant, a fuselage (or parts thereof) of the apparatus can be independently controlled, including for example as to attitude relative to other components of the craft.

### PRIORITY AND RELATED APPLICATIONS DATA

This application claims the benefit of priority to co-owned and co-pending U.S. Provisional Patent Application Ser. No. 62/174,417 filed Jun. 11, 2015 of the same title, the contents of which being incorporated herein by reference in its entirety.

This application is related to co-owned and co-pending U.S. patent application Ser. No. 14/659,282 filed Mar. 16, 2015 and entitled “Vertical Short Takeoff and Landing Apparatus”, which is a continuation of and claims priority to U.S. patent application Ser. No. 13/675,707 filed Nov. 13, 2012 entitled “Methods and Apparatus for Vertical Short Takeoff and Landing”, now U.S. Pat. No. 8,979,016, which claims priority to U.S. Provisional Patent Application Ser. No. 61/560,667 filed Nov. 16, 2011 entitled “Methods and Apparatus for Vertical Short Takeoff and Landing”, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates generally to the fields of aviation and aerospace engineering. More particularly, in one exemplary aspect, the present disclosure is directed to methods and apparatus for vertical short takeoff and landing, and also in certain aspects to operational control of such apparatus.

2. Description of Related Technology

A wide range of aviation related applications require flexibility in aircraft movement. Common requirements are vertical or short takeoff, hovering capabilities, and frequent changes in flight vector, etc. Additionally, unmanned aircraft are in high demand for defense or other applications (such as drug surveillance or interdiction) in which deploying personnel is either too dangerous or impractical given the task requirements.

It is impossible to design aircraft that meet the needs of every aviation application. Therefore, having a wide variety aircraft designs utilizing a wide variety of flight systems (e.g. propulsion, takeoff, landing etc) is necessary to match the requirements of a multitude of tasks. However, given monetary constraints, there is a practical limit to the number of aircraft that can be manufactured and dedicated to any specific purpose or group. Moreover, there are significant economies of scale and other attendant benefits when a given platform (or set of closely related platforms) can be “repurposed” or reconfigured to suit different tasks, akin to the extant Lockheed Martin F-35 Lightning II paradigm. Therefore, it is important that selected designs offer the broadest task flexibility possible, while not overlapping unduly with aircraft already in widespread use.

Existing solutions for vertical short takeoff and landing (VSTOL) generally either comprise: (i) those driven by a main rotor stabilized via a tail rotor (e.g., helicopter), (ii) more traditional airplane driven by engines or turbines the can be placed in multiple orientations (e.g., V-22 Osprey or Harrier jets, or the “B” variant of the aforementioned F-35), or (iii) small craft dependent on one or more turbines (Multipurpose Security and Surveillance Mission Platform or SoloTrek Exo-Skeletor Flying Vehicle). While the more traditional plane designs offer high-top speeds, and increase mission range/duration via gliding capabilities, these systems are limited in the speed at which they can accommodate a significant change in flight vector. Thus, these vehicles would be inappropriate for e.g., low-altitude applications in an urban environment. Conversely, helicopters and smaller turbine based craft lack the capability to remain aloft without expending significant power or fuel resources to keep their turbines running. Moreover, all of these vehicles have a preferred orientation such that if they become inverted, the craft will have to be righted before lift capability can be restored.

Unfortunately, modern applications often require both flight through confined areas and long on-station dwell or long-range deployment of the aircraft. Moreover, vehicles used in such applications may often experience violent disruptions or turbulence in their immediate airspace. Thus, losing lift capability as a result of environmental conditions or an unexpected inversion is a significant operational limitation.

Accordingly, improved solutions are required for VSTOL, as well as control during operation. Such improved solutions should ideally be flexible enough for urban or other confined area navigation, be able to generate lift in multiple orientations, and have suitable on-station dwell and range operational capacity, all with low operational and maintenance cost (e.g., dollars per flight hour).

### SUMMARY

The present disclosure satisfies the aforementioned needs by providing, inter alia, improved methods and apparatus for vertical short takeoff and landing, and operational control.

In a first aspect of the disclosure, a VSTOL apparatus is disclosed. In one embodiment, the VSTOL apparatus includes a fuselage; a fuselage ring coupled at two or more connection points with the fuselage; a plurality of airfoils; a power ring coupled to respective ones of the plurality of airfoils; and a control ring that is communicatively coupled with respective ones of the plurality of airfoils. The fuselage is configured to rotate with respect to the fuselage ring.

In one variant, the two or more connection points consist of two connection points.

In another variant, the two connection points are configured to enable the fuselage to independently rotate with respect to the fuselage ring, the power ring and the control ring.

In yet another variant, the two or more connection points comprise two or more dynamic connections with the fuselage, the two or more dynamic connections configured to enable out-of-plane movement of the fuselage with respect to the fuselage ring.

In yet another variant, the VSTOL apparatus further includes a tether apparatus coupled to the fuselage, the tether apparatus configured to enable one or more of a power source for the VSTOL apparatus, a communications payload for the VSTOL apparatus and VSTOL operators for the VSTOL apparatus to be located remote from the fuselage.

In yet another variant, the power ring comprises a plurality of undulations, the plurality of undulations configured to be driven by one or more gear sprockets.

In yet another variant, the VSTOL apparatus further includes an additional power ring that also consists of a plurality of additional undulations.

In yet another variant, a single gear sprocket is configured to drive both the power ring and the additional power ring in a substantially counter-rotating fashion.

In yet another variant, the VSTOL apparatus further includes an articulation system, the articulation system including: an articulation cam comprising a power rod configured to couple with the power ring and a control rod configured to couple with the control ring; and a guide slot resident within the control ring, the control rod configured to traverse the guide slot. The articulation cam is configured to rotate with respect to the power rod, the rotation of the articulation cam configured to articulate the control ring with respect to the power ring.

In yet another variant, the power ring includes a pair of power rings and the control ring includes a pair of control rings and the VSTOL apparatus further comprises an articulation system, the articulation system including: a control arm that is sandwiched between a pair of control wheels; and a groove is positioned within each of the pair of control rings, respective ones of the pair of control wheels positioned within respective ones of the control ring grooves. A separation of the pair of control wheels with respect to one another is configured to articulate respective ones of the pair of control rings.

In yet another variant, the power ring is configured to rotate with respect to the control ring and the VSTOL apparatus further includes an articulation system, the articulation system including: a power rod that couples an airfoil to the power ring; a control cam arm that is coupled with the airfoil and a swivel wheel mount; and a control ring guide located on the control ring, the control ring guide configured to receive the swivel wheel mount. The articulation of the control ring is configured to articulate the airfoil via the control cam arm.

In yet another variant, the power ring is configured to rotate with respect to the control ring and the VSTOL apparatus further includes an articulation system, the articulation system including: a single control cam arm comprised of a swivel wheel mount, the single control cam arm configured to be coupled with an airfoil, the single control cam arm further configured to be received within the power ring via a bearing. An articulation of the control ring is configured to articulate the airfoil via the single control cam arm.

In yet another variant, the swivel wheel mount includes at least two wheels, the at least two wheels providing for additional stabilization during articulation.

In yet another variant, the power ring includes a pair of power rings and the VSTOL apparatus further includes an articulation system, the articulation system including: an articulation rod coupled to a pair of power ring wheels, each of the power ring wheels of the pair configured to interface with a respective power ring of the pair at a top surface thereof; and a control ring arm that is coupled to a control ring wheel, the control ring arm disposed between the pair of power ring wheels, the control ring wheel configured to interface with the control ring at a top surface thereof. The articulation of the articulation rod is configured to articulate the control ring with respect to the pair of power rings thereby articulating one or more of the plurality of airfoils.

In a second aspect of the disclosure, methods of operating the VSTOL apparatus are disclosed. In one or more embodiments, methods of operating the aforementioned VSTOL apparatus are disclosed.

In a third aspect of the disclosure, methods of using the VSTOL apparatus are disclosed. In one or more embodiments, methods of using the aforementioned VSTOL apparatus are disclosed.

In a fourth aspect of the disclosure, an articulation system for use with the VSTOL apparatus is disclosed. In one embodiment, the articulation system includes an articulation cam comprising a power rod configured to couple with the power ring and a control rod configured to couple with the control ring; and a guide slot resident within the control ring, the control rod configured to traverse the guide slot. The articulation cam is configured to rotate with respect to the power rod, the rotation of the articulation cam configured to articulate the control ring with respect to the power ring.

In another embodiment, the articulation system includes: a control arm that is sandwiched between a pair of control wheels; and a groove is positioned within each of a pair of control rings, respective ones of the pair of control wheels positioned within respective ones of the control ring grooves. A separation of the pair of control wheels with respect to one another is configured to articulate respective ones of the pair of control rings.

In yet another embodiment, the articulation system includes: a power rod that couples an airfoil to a power ring; a control cam arm that is coupled with the airfoil and a swivel wheel mount; and a control ring guide located on a control ring, the control ring guide configured to receive the swivel wheel mount; wherein an articulation of the control ring is configured to articulate the airfoil via the control cam arm.

In yet another embodiment, the articulation system includes: a single control cam arm comprised of a swivel wheel mount, the single control cam arm configured to be coupled with an airfoil, the single control cam arm further configured to be received within a power ring via a bearing; wherein an articulation of a control ring is configured to articulate the airfoil via the single control cam arm.

In one variant, the swivel wheel mount includes at least two wheels, the at least two wheels providing for additional stabilization during articulation.

In yet another embodiment, the articulation system includes: an articulation rod coupled to a pair of power ring wheels, each of the power ring wheels of the pair configured to interface with a respective power ring of a pair at a top surface thereof; and a control ring arm that is coupled to a control ring wheel, the control ring arm disposed between the pair of power ring wheels, the control ring wheel configured to interface with a control ring at a top surface thereof; wherein articulation of the articulation rod is configured to articulate the control ring with respect to the pair of power rings thereby articulating one or more of the plurality of airfoils.

In a fifth aspect of the disclosure, methods of operating an articulation system of a VSTOL apparatus are disclosed. In one or more embodiments, methods of operating the aforementioned articulation systems are disclosed.

In a sixth aspect of the disclosure, methods of using an articulation system of a VSTOL apparatus are disclosed. In one or more embodiments, methods of using the aforementioned articulation systems are disclosed.

In a seventh aspect of the disclosure, business methods relating to the VSTOL apparatuses are disclosed. In one or more embodiments, business methods associated with the aforementioned VSTOL apparatus are disclosed.

In an eighth aspect, a lightweight tethering system useful for transferring “electrical” power and/or data is disclosed.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a perspective view of a first exemplary embodiment of a vertical short takeoff and landing (VSTOL) apparatus in accordance with the principles of the present disclosure.

FIG. 2 is a perspective view of a second exemplary embodiment of a vertical short takeoff and landing (VSTOL) apparatus in accordance with the principles of the present disclosure.

FIG. 3 is a perspective view of a third exemplary embodiment of a vertical short takeoff and landing (VSTOL) apparatus in accordance with the principles of the present disclosure.

FIG. 4 is a perspective view of a first exemplary embodiment of an articulation/rotation system for use with, for example, the VSTOL apparatus of FIGS. 1-3 in accordance with the principles of the present disclosure.

FIG. 5 is a perspective view of a second exemplary embodiment of an articulation/rotation system for use with, for example, the VSTOL apparatus of FIGS. 1-3 in accordance with the principles of the present disclosure.

FIG. 6 is a perspective view of a third exemplary embodiment of an articulation/rotation system for use with, for example, the VSTOL apparatus of FIGS. 1-3 in accordance with the principles of the present disclosure.

FIG. 7 is a perspective view of a fourth exemplary embodiment of an articulation/rotation system for use with, for example, the VSTOL apparatus of FIGS. 1-3 in accordance with the principles of the present disclosure.

FIG. 8 is a perspective view of a fifth exemplary embodiment of an articulation/rotation system for use with, for example, the VSTOL apparatus of FIGS. 1-3 in accordance with the principles of the present disclosure.

FIG. 9 illustrates various views demonstrating the flight capabilities of, for example, the VSTOL apparatus shown and described with respect to FIGS. 1-3 in accordance with the principles of the present disclosure.

### DETAILED DESCRIPTION

Reference is now made to the drawings, wherein like numerals refer to like parts throughout.

### Overview

In one aspect, the present disclosure provides methods and apparatus for vertical short takeoff and landing (VSTOL). In one embodiment, the apparatus uses contra-rotating rings (e.g., two) with a plurality of articulating airfoils attached at the circumference of each to generate lift. The apparatus can be driven by one or more electric motors supplied by photovoltaic (solar) cells, one or more battery cells, by a combustion engine (e.g., two-stroke, four stroke, or even turbojet), or alternatively via satellite downlink supplying an electromagnetic (e.g., microwave range) radiation beam which would each supply power to a drive arrangement that is completely contained within the apparatus.

In an alternative embodiment, the VSTOL apparatus described herein may also utilize a tether thereby enabling the power source to be located remote from the VSTOL apparatus. The tether apparatus can also be configured to provide data communications thereby providing, for example, a distributed arrangement for communication between the VSTOL apparatus/system and a remote communications center.

Various articulation/rotation systems are disclosed for use in the variety of differing VSTOL apparatus concepts are also disclosed.

### DETAILED DESCRIPTION OF EXEMPLARY EMBODIMENTS

Exemplary embodiments are now described in detail. While these embodiments are primarily discussed in the context of an unmanned VSTOL aircraft, it will be recognized by those of ordinary skill that the present disclosure is not so limited. In fact, the various aspects are useful for VSTOL in a variety of other contexts which include manned VSTOL applications. For example, embodiments may be readily adapted for use as remote viewing and/or other sensory aids (e.g., audio, IR, ionizing, radiation, electromagnetic radiation such as wireless communications) for law enforcement, drug interdiction, search and rescue, or even for surveillance such as by private investigators. Similarly, embodiments (whether manned or unmanned) could be used for, for example, opportunistic equipment deployment (sport events, disaster areas, emergency response zones, etc.).

Furthermore, while the disclosure is discussed primarily in the context of generating lift in a gaseous fluid medium such as the earth's atmosphere, it will be recognized by those of ordinary skill that the architectures and principle disclosed herein could be readily adapted for use in other operating environments, such as liquids, with the discussion using gaseous mediums merely being exemplary.

It will also be recognized that while particular dimensions are associated with the exemplary embodiments disclosed herein for the apparatus or its components, the apparatus may advantageously be scaled to a variety of different sizes, depending on the intended application. For instance, the disclosure contemplates a small table-top or even hand-held variant which may be useful for, for example, low altitude surveillance or the like. Likewise, a larger-scale variant is contemplated, which may carry a more extensive array of sensors, personnel (e.g., in rescue operations) and even weapons (such as e.g., Hellfire precision guided munitions or the like), have greater loiter and altitude capabilities, etc. This design scalability is one salient advantage of the apparatus and methods described herein.

### Exemplary Apparatus and Operation—

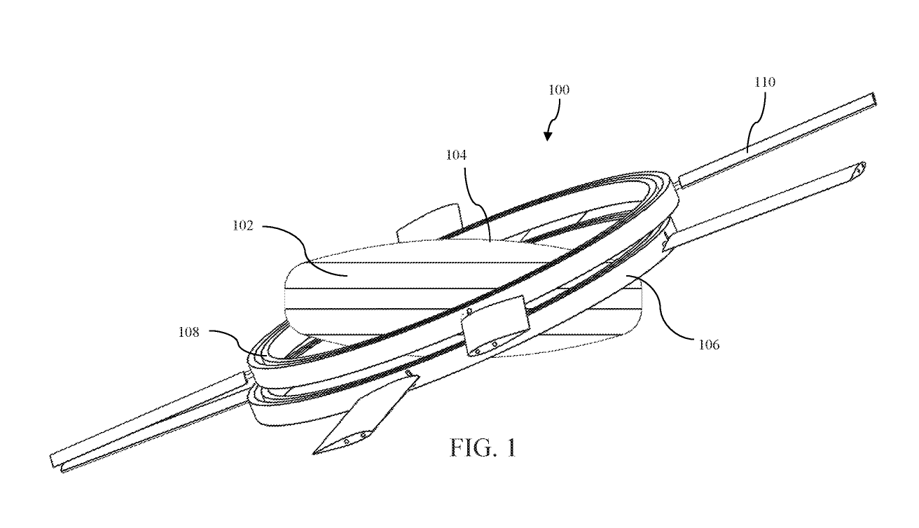

Referring now to FIG. 1, an exemplary embodiment of a VSTOL apparatus 100 is shown and described in detail. The VSTOL apparatus illustrated includes a fuselage 102 that is coupled to a body ring 104 as well as, in an exemplary embodiment, two sets of counter-rotating rings (i.e., control rings 106 and power rings 108). In the illustrated embodiment, the fuselage comprises a disc-shaped fuselage that is supported within the rings. This placement of the fuselage with respect to the rings is effective in that no torque will be imparted on the fuselage; thereby keeping it substantially fixed in orientation during flight as discussed in additional detail infra. The placement of the fuselage within the central portion of the VSTOL apparatus further reduces the strain experienced by the airfoils 110. Additionally, the lack of a central hub or axle increases the room available for cargo (e.g., personnel, sensors, communications equipment, cameras, munitions, etc.) within the fuselage. Another key advantage of this design is that it facilitates an aerodynamic fuselage. The disc shape allows for a large volume while still maintaining a relatively small cross-section with respect to the direction of transverse flight (e.g., laterally). This will lead to reduced power loss due to drag, and a reduced radar cross section (RCS) as discussed in greater detail subsequently herein.

The utilization of the rings in combination with a substantially fixed fuselage allows for a highly agile craft as actions, such as turning, can be performed with effectively a zero radius and with only minimal power expenditure. Moreover, as the fuselage is not intended to rotate (at least with regards to the rotating power rings 108 and optionally control rings 106), angular momentum is minimized resulting in a much more agile aircraft. For example, a brake (e.g., a frictional mechanism) could be applied to the one or more of the rotating rings, resulting in axial rotation and hence enabling the VSTOL apparatus to turn while, for example, hovering in place. The fuselage itself can be manufactured from any number of suitable materials including, for example, a low-weight, high strength carbon fiber. Moreover, other fuselage embodiments as described in co-owned U.S. Pat. No. 8,979,016, the contents of which were previously incorporated herein by reference in its entirety could be utilized including, for example, lightweight composite materials (e.g., graphite-based or urethane-based using epoxies as bonding agents) for both strength and reduced weight. As yet another alternative, metallic materials/alloys could also be readily utilized (in whole or in part) and incorporated into the fuselage structures described herein.

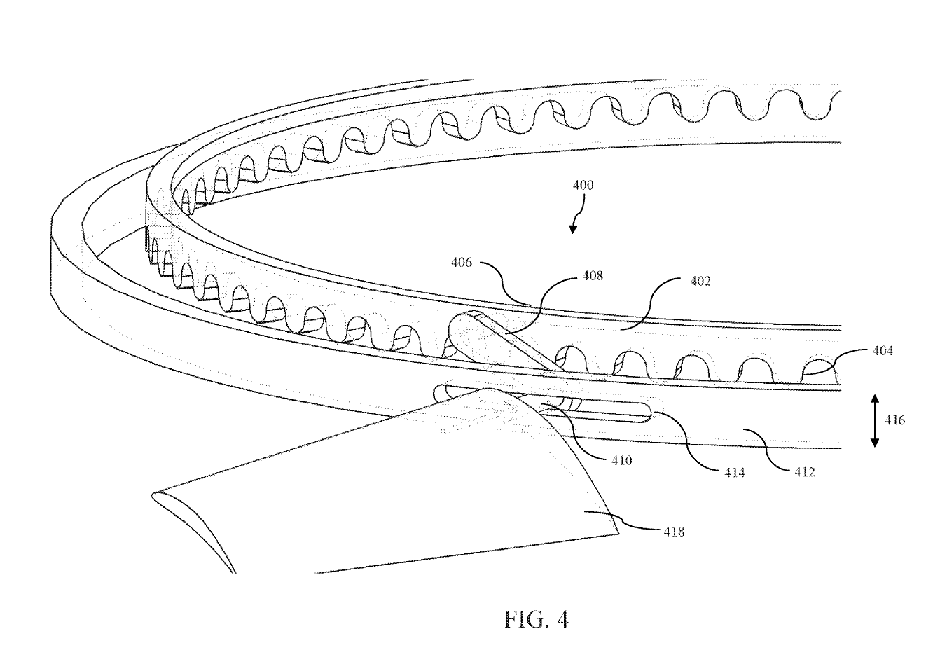

In variants that incorporate counter-rotating pairs of rings (see, for example, the articulation apparatus described with regards to U.S. Pat. No. 8,979,016 incorporated supra as well as FIGS. 4, 5 and 8 discussed infra), each set of counter-rotating rings will include one or more control rings 106 as well as one or more power rings 108 with a number (e.g., four) of airfoils 110 coupled thereto. While the VSTOL apparatus illustrated in FIG. 1 consists of a total of eight (8) airfoils with four (4) airfoils coupled to each set of counter-rotating rings, it is readily appreciated that more or less airfoils can be incorporated into the VSTOL apparatus. In one embodiment, one or more of the illustrated airfoils will incorporate a mechanism that enables the surface area for the airfoil to extend and/or contract as is described in co-owned U.S. Pat. No. 8,979,016, the contents of which were previously incorporated herein by reference in its entirety. For example, in one exemplary embodiment, the airfoils 110 will comprise radially extensible airfoils that permit the effective length of the airfoil to change. In one variant, the extensible portion is configured to slide outward from within the non-extensible portion, thereby increasing the effective length (and hence lift provided by) each airfoil. Such extensibility may be desirable for e.g., changing altitude, operating at different altitudes (i.e., having different air densities), changing the efficiency of the apparatus, maneuvering, altering the radar cross-section (RCS) of the aircraft, etc. Radially extensible airfoils are described in co-owned U.S. Pat. No. 8,979,016, the contents of which were previously incorporated herein by reference in its entirety.

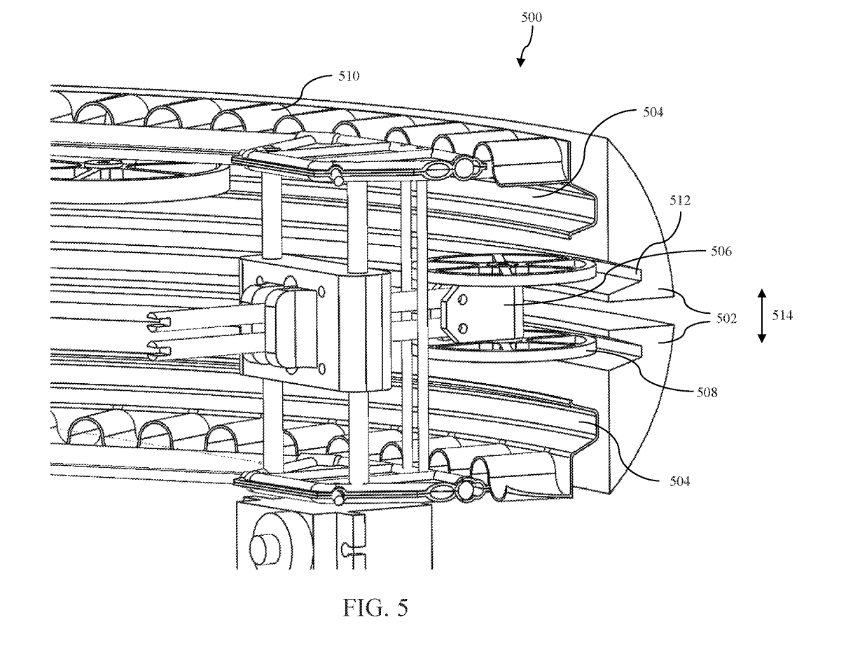

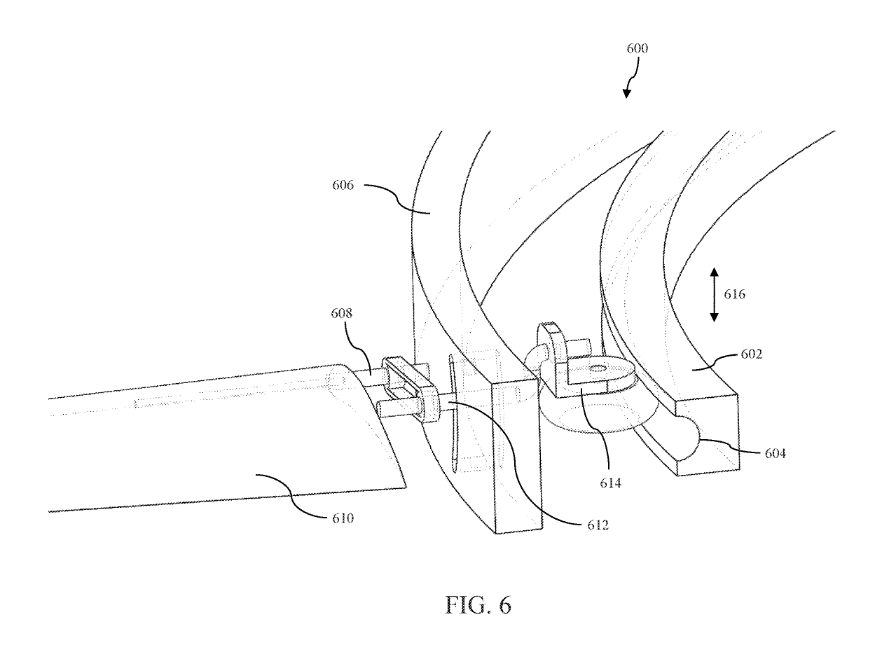

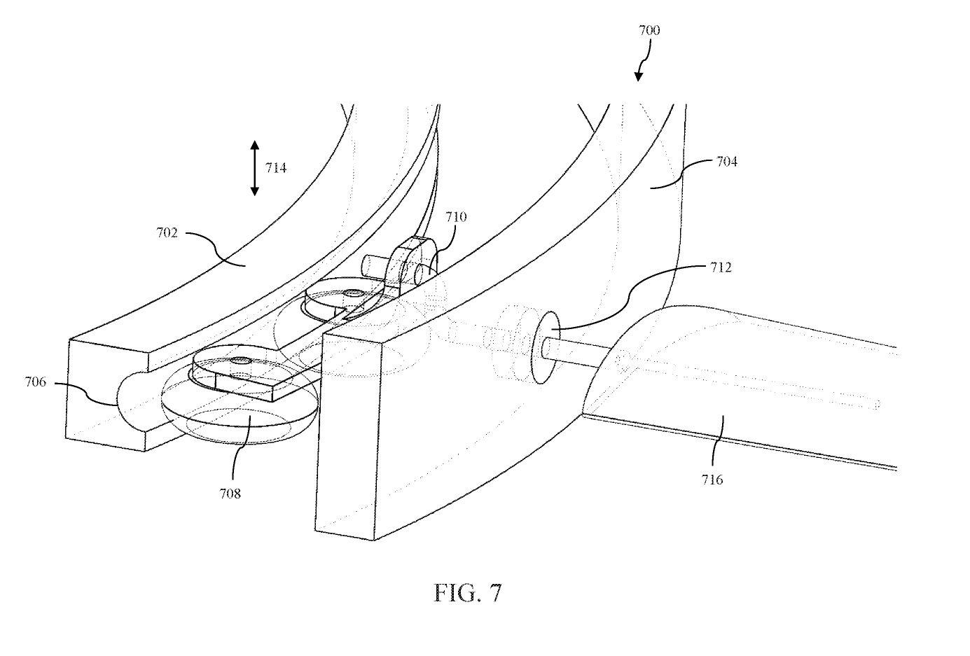

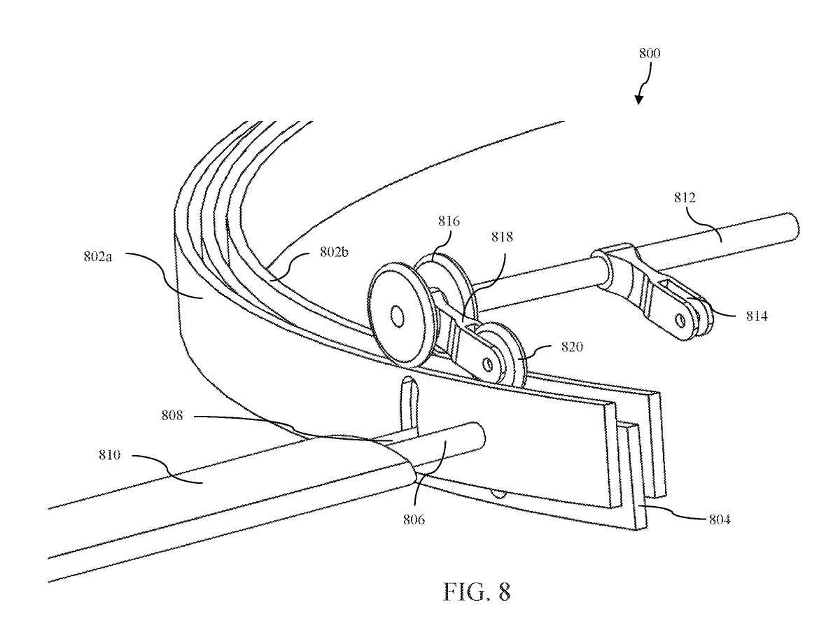

In one exemplary embodiment, the rotation and articulation mechanism for each set of counter-rotating rings is described in co-owned U.S. Pat. No. 8,979,016, the contents of which were previously incorporated herein by reference in its entirety. In alternative embodiments, the rotation and articulation mechanism is as shown and described with respect to FIG. 4; FIG. 5; FIG. 6; FIG. 7; or FIG. 8 as will be discussed subsequently herein. The embodiment illustrated in FIG. 1 also includes a body ring 104 that differs from, for example, the counter-rotating power rings 108 in that the body ring is configured to remain fixed (i.e., not rotate) with respect to the fuselage 102, while the power (and optionally the control rings 106), in various embodiments described herein, do rotate. Moreover, it can also be appreciated that advantages from gear reduction (e.g., between the output shaft of the drive source, such as a motor or engine, and the drive applied to the rings) can easily be leveraged using the contra-rotating ring design described herein. In fact, the rings themselves can act as the main reduction gears given that the drive system of the VSTOL apparatus is located entirely within the circumference of the rings.

As shown in FIG. 1, the fuselage 102 is configured to independently rotate with respect to the body ring 104 and each pair of counter-rotating rings (albeit generally orthogonal in orientation). In other words, the relative position of the fuselage can be maintained independent from the positioning of the counter-rotating rings. In the illustrated embodiment, the fuselage is coupled to the body ring at two (2) discrete connection points (not shown) thereby enabling this independent rotation. These connection points are coupled, either statically or dynamically, onto opposing ends of the fuselage. For example, in statically coupled embodiments, these connection points will remain fixed in relation to their relative attachment position on the fuselage (i.e., coupled to the fuselage at distinct locations). Alternatively, in dynamically coupled embodiments, these connection points will enable out-of-plane movement of the fuselage 102 with respect to the body ring 104. Moreover, by including two (2) discrete connection points, the counter-rotating rings (and optionally body ring) could rotate a full three-hundred sixty degrees (360°) about the fuselage 102.

The benefits for this independent movement of the fuselage with respect to the body ring and counter-rotating rings are potentially many fold. For example, in VSTOL apparatus embodiments in which the fuselage is configured to house one or more personnel (e.g., an operator of the VSTOL apparatus), this independent movement enables the occupants to be positioned in relative comfort independent from the movement of the rings. In other words, the positioning of the fuselage can be maintained in an orientation where passenger comfort and/or substantially constant reference to the local gravitational field vector is a primary consideration while the counter-rotating rings can be positioned so as to efficiently maneuver the VSTOL apparatus between two or more physical locations. For example, in coast guard rescue applications, the VSTOL apparatus could be deployed to a sea-bearing vessel and lowered onto the deck in order to pick up injured personnel. The VSTOL apparatus can then return to land (or any other desired location) while maintaining the injured personnel in a desirable orientation, even in otherwise turbulent weather conditions which necessitate rapid, unpredictable movement of, for example, the counter-rotating sets of rings.

As yet another example, in VSTOL apparatus embodiments in which line-of-sight communications equipment is housed within or coupled to the fuselage, the sightline for the communication equipment can, within limits, be maintained independent from the movement of the counter-rotating rings. In other words, the orientation/directionality of the communications link can be maintained that enables communication between the communications equipment of the VSTOL apparatus and remote communications equipment via manipulation of fuselage orientation while allowing for independent movement of the VSTOL apparatus as a whole between two or more physical locations. As but one example, communications with a geosynchronous satellite or land-based repeater station can be maintained by keeping the fuselage in a desired pitch/roll/yaw configuration relative to the remainder of the craft, which may be in a different orientation (and/or moving relative to the fuselage).

As yet another example, in embodiments in which the VSTOL apparatus fuselage payload includes photography equipment, the object intended to be captured by the photography equipment can be separately tracked/maintained independent from the movement of the counter-rotating rings and the VSTOL apparatus itself. These and other benefits associated with independent movement between the fuselage and the counter-rotating rings would be readily understood by one of ordinary skill given the contents of the present disclosure.

In other variants, the VSTOL apparatus may also include a tether (not shown) that enables the VSTOL apparatus to be coupled to another apparatus or system. This tether can provide operational power for the VSTOL apparatus as well as communications pathways between the VSTOL apparatus and the other apparatus or system. For example, the VSTOL apparatus illustrated in FIG. 1 could be tethered to, e.g., an emergency response vehicle having a generator for producing electrical power, such as via a lightweight tether cord. In situations such as forest fires, this emergency response vehicle could be quickly deployed to the front line, the VSTOL apparatus deployed and information obtained from the VSTOL apparatus could be utilized to provide firefighting crews with up-to-date information such as the location of the fire, movement and speed of the fire and other critical information necessary to maintain the safety of the firefighting crews. Additionally by including a tether, the weight of the VSTOL apparatus can be substantially reduced and the period of operation for the VSTOL apparatus extended by locating the power source, communications equipment, VSTOL operators, etc. (or at least portions or some components thereof), separate and apart from the VSTOL apparatus itself. Moreover, while embodiments in which the power source is located independent from the VSTOL apparatus are disclosed, it is appreciated that the power source (e.g., solar cell, battery, or engine, etc.) could be housed within the fuselage along with motor(s) to drive the rotation of the rings, fuselage and to articulate the airfoils, as well as optionally being supplemented by electrical power and/or data signals via the tether.

It will be appreciated that various configurations of the aforementioned tether (when used) can be employed consistent with the present disclosure. For example, in one variant, an optical fiber (or bundle of fibers) can be used to transmit both data and “electrical” power between the tethered device and its host. In one implementation, data is carried on one or more dedicated data fiber strands (such as via an optical modulator/demodulator pair), and electrical power is converted to the optical domain (such as via a laser diode) and transmitted over the fiber. It is highly feasible using technology extant as of the date of this filing to transmit several watts (J/s) of electrical power via such an arrangement, which can be used to power one or more functions within the VSTOL (tethered) device on an intermittent or continuous basis, including even to charge an indigenous battery on the VSTOL device, while also maintaining a minimum weight (and hence load and drag on the VSTOL device during flight. As another alternative, a lightweight ultra-fine gauge copper or other filament can be used to transmit signals and/or electrical power, or any combinations of the foregoing can be used (or other techniques not described herein but readily apparent to one of ordinary skill given the present disclosure).

These and other variant applications, such as those described with regards to co-owned U.S. Pat. No. 8,979,016, the contents of which were previously incorporated herein by reference in its entirety are also envisioned.

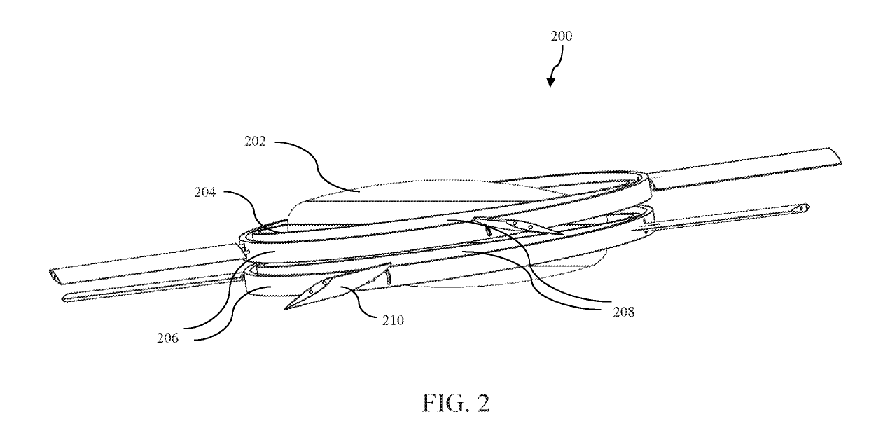

Referring now to FIG. 2, a variant of the VSTOL apparatus shown in, for example, FIG. 1 is shown and described in detail. Specifically, the primary difference between the VSTOL apparatus illustrated in FIG. 1 and the VSTOL apparatus 200 illustrated in FIG. 2 is the number of connections between the fuselage 202 and the body ring 204. In the illustrated embodiment, the number of connections between the fuselage and the body ring is three (3), although it is envisioned that additional connection points may be included in alternative variants. However, unlike embodiments described with regards to FIG. 1, each of the connection points must comprise dynamic connection points (as opposed to the option of static or dynamic connection points as described with regards to FIG. 1). The dynamic connection points are necessary in order to enable the articulation of the fuselage independent from the relative positioning of the sets of counter-rotating power 208 and control rings 206 (and corresponding body ring 204 and airfoils 210). However, unlike the embodiment illustrated and described with respect to FIG. 1, the amount of potential articulation for the fuselage will be limited as compared with the full three-hundred and sixty degree (360°) articulation of the embodiment illustrated in FIG. 1; however, the fuselage in the embodiment illustrated in FIG. 2 will be allowed to pitch/roll in multiple degrees of freedom as opposed to the single degree of freedom fuselage rotation shown with regards to static connection point embodiments described with regards to FIG. 1. All other variants, embodiments and applications (other than the inclusion of the two connections points discussed with regards to FIG. 1) can readily be incorporated within the embodiment illustrated with respect to FIG. 2.

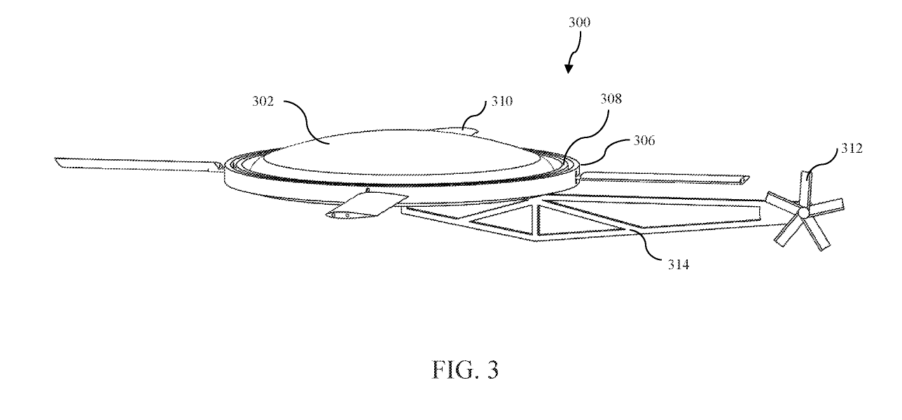

Referring now to FIG. 3, yet another variant of a VSTOL apparatus 300 is shown and described in detail. The VSTOL apparatus shown in FIG. 3 differs from that shown in FIGS. 1 and 2 in that the VSTOL apparatus merely includes a single control ring 306 and a single power ring 308. The second set of control/power rings has been obviated in the illustrated embodiment by inclusion of a tail rotor 312 coupled to a tail rotor support structure 314. A body ring (not shown) is incorporated within the fuselage 302 which enables the fuselage to articulate independently from the control ring 306/power ring 308 pair. While the embodiment illustrated in FIGS. 1 and 2 utilizes the counter-rotating set of rings in order to stabilize the orientation of the VSTOL apparatus, the embodiment illustrated in FIG. 3 utilizes the tail rotor support structure 314 in combination with the tail rotor 312 in order to achieve this desired level of stability, control flight direction, etc. The embodiment illustrated in FIG. 3 can also include many of the features described previously herein with regards to FIGS. 1 and 2 (i.e., the two or more fuselage connection points to the body ring) as well as extensible airfoils (e.g., radially extensible and/or extensible control surface on the airfoils themselves). Moreover, the embodiment of FIG. 3 can readily utilize the articulation/rotation systems as shown in FIG. 4; FIG. 5; FIG. 6; FIG. 7; or FIG. 8 discussed infra or alternatively, the articulation/rotation system as described in co-owned U.S. Pat. No. 8,979,016, the contents of which were previously incorporated herein by reference in its entirety. All other variants, embodiments and applications as described with respect to FIGS. 1 and 2 can readily be incorporated within the embodiment illustrated with respect to FIG. 3.

### Exemplary Articulation/Power Mechanisms and Operation—

Referring now to FIG. 4, details of an exemplary configuration of an articulation/rotation system 400 for the airfoils 418 is shown. The illustrated articulation/rotation system consists of a power ring 402 along with a corresponding control ring 412. While a single set of a power ring/control ring combination is illustrated, it is readily appreciated that a second (or more) power ring/control ring combinations (not shown) could readily be incorporated depending upon the specific VSTOL apparatus (e.g., 100, 200, 300) configuration chosen. The illustrated single set power ring/control ring combination is merely intended to illustrate the principles of articulation/rotation system operation.

Referring back to the power ring 402 illustrated in FIG. 4, this power ring includes a bottom set of undulations 404 (e.g., teeth) that is configured to be driven by one or more corresponding gear sprockets (not shown). This gear sprocket will be driven by, for example, an electric motor although it is readily appreciated that other suitable power sources/motors can be utilized to drive the gear sprocket depending upon the specific design constraints for the VSTOL apparatus. Moreover, a single gear sprocket can be utilized to drive two distinct power rings. For example, a single gear sprocket that is configured to rotate in a clockwise manner (as viewed from the outside of the VSTOL apparatus) will drive an upper power ring in a counter-clockwise direction, while simultaneously driving a lower power ring in a clockwise direction. In other words, when the gear sprocket is positioned between an upper and a lower power ring, the exemplary counter-rotating operation of the two sets of control/power rings can be achieved by a single gear sprocket driving both power rings simultaneously. Alternatively, in embodiments that utilize two counter-rotating power rings, each of these power rings can be separately driven by two distinct gear sprockets with each gear sprocket associated with a given power ring. Moreover, while primarily discussed in the context of a single gear sprocket driving one or two power rings; it is readily appreciated that more gear sprockets could be readily incorporated where desired, whether distributed evenly or unevenly around the circumference of the power ring(s) are also envisioned.

The articulation system also includes a separate control ring 412 that is configured to articulate in the direction generally designated 416. In one embodiment, this articulation is driven by a stepper motor (not shown) which turns a screw thread (not shown). The screw thread controls the position of the control ring (i.e., depresses or raises the control ring). This articulation alters the relative position of the control ring 412, and articulates the airfoils 418. The control ring is configured to rotate with its respective power ring 402. As the control ring is raised or depressed, the airfoil is articulated by virtue of its attachment to the articulation cam 408 and its connection to the power ring via power rod 406 and control rod 410. The power rod is coupled to the power ring via a bearing while the control rod is coupled to the airfoil in a fixed fashion. As the control ring is raised or depressed, the control rod will traverse the guide slot 414, thereby enabling the articulation of the airfoils 418. Again, while a single control ring 412/power ring 402 combination is shown, it is readily appreciated that the specific number of control ring/power ring pairs will be governed by the underlying VSTOL configuration chosen (e.g., FIG. 1, 2, or 3).

In an alternative variant, the articulation of the control ring 412 will be driven by an actuator that is configured to rotate the power rod 406 within the power ring 402. As this actuator rotates the power rod within the power ring, the articulation cam 408 along with the corresponding airfoil 418 will articulate either in an upward or downward fashion. In this way, each of the airfoils can be articulated independently from other ones of the airfoils (not shown) attached to the power ring 402.

Moreover, while a guide slot 414 is illustrated, it is appreciated that in certain embodiments, the guide slot 414 may be obviated altogether. Rather, the guide slot could be replaced by a bearing connection between the control rod 410 and the control ring 412. However, in such implementations, each of the airfoils will have to be articulated concurrently for a given control ring 412/power ring 402 pair (i.e., the ability to separately articulate each of the airfoils will be substantially limited with respect to a given power ring).

Referring now to FIG. 5, an alternative articulation/rotation system 500 is shown and described in detail. In the illustrated embodiment, the power rings 504 are similar in construction to the embodiment illustrated in FIG. 4. In other words, the power rings include a number of undulations 510 that can be driven by one or more sprocket gears (not shown) distributed at one or more locations along the circumference of the power ring. In one embodiment, a single gear sprocket can be utilized to drive two distinct power rings 504 such that when a single gear sprocket that is configured to rotate in a clockwise manner (when viewed externally to the VSTOL apparatus) will drive an upper power ring in a counter-clockwise direction, while simultaneously driving a lower power ring in a clockwise direction. In other words, when the gear sprocket is positioned between an upper and a lower power ring, the exemplary counter-rotating operation of the two sets of control/power rings can be achieved by a single gear sprocket driving both power rings simultaneously. Alternatively, in embodiments that utilize two counter-rotating power rings, each of these power rings can be separately driven by two distinct gear sprockets with each gear sprocket associated with a given power ring. Moreover, while primarily discussed in the context of a single gear sprocket driving one or two power rings; it is readily appreciated that more gear sprockets could be readily incorporated where desired, whether distributed evenly or unevenly around the circumference of the power ring(s) are also envisioned.

The articulation of the control rings 502 will be driven by a control arm 506 that is sandwiched between a pair of control wheels 508. These control wheels are configured to run within a groove 512 located within respective control rings. By articulating the control arm in a vertical direction 514 (i.e., raise or depress the control rings 502), the articulation of the airfoils (not shown) can be readily achieved. Moreover, while the distance between control wheels 508 is illustrated as being fixed, it is appreciated that the distance between each of these control wheels can be separately articulated, giving a more independent range of motion for each of the control rings. Note that in the illustrated embodiment, the power rings 504 and the control rings 502 are configured to rotate in unison (albeit in a counter-rotating fashion) with respect to its counterpart (i.e., upper control ring 502 rotates in unison with upper power ring 504, while lower control ring 502 rotates in unison with the lower power ring 504).

Referring now to FIG. 6, yet another alternative articulation/rotation system 600 is shown and described in detail. Similar to the embodiments previously discussed, the articulation system shown in FIG. 6 includes both a power ring 606 as well as a control ring 602. However, unlike the articulation systems previously discussed, the control ring 602 in the illustrated embodiment does not rotate with the power ring 606. Rather, the control ring is affixed to the outside of the fuselage (or alternatively, a body ring) depending upon the implementation desired and the range of motion for the control ring is merely constrained in a vertical direction 616. The airfoils 610 are coupled to the power ring via an articulating stabilizer rod 608; while simultaneously being coupled to the swivel wheel mount 614 via the control cam arm 612. Accordingly, the articulation of the airfoil is achieved as the swivel wheel mount runs along control ring guide 604 and the control ring is articulated up or down along vertical axis 616. The articulating stabilizer rod 608 is coupled to the power ring 606 via a bearing which enables the control cam arm to rotate as the swivel wheel mount is guided via the articulated control ring. Again, while illustrated as including a single power ring 606/control ring 602 pair, it is readily appreciated that two (or more) power ring/control ring pairs could readily be utilized depending upon the VSTOL apparatus (e.g., VSTOL apparatus 100, 200, or 300) chosen.

Referring now to FIG. 7, a single shaft variant of the articulation/rotation system of FIG. 6 is shown and described in detail. Specifically, and similar to the embodiment discussed above with respect to FIG. 6, the control ring 702 does not rotate while the power ring 704 rotates about, for example, a fuselage as shown in FIGS. 1-3. The control ring is affixed to the outside of the fuselage (or alternatively, a body ring) depending upon the implementation desired and the range of motion for the control ring is merely constrained in a vertical direction 714. The airfoils 716 are coupled to the power ring 704 via a control cam arm 710 that resides within a bearing 712 mounted within the power ring. The bearing 712 provides a low friction surface for the articulating control cam arm while simultaneously providing stability for the airfoil. Additionally, the articulation of the airfoil is achieved as the dual swivel wheel mounts 708 run along the control ring guide 706 and the control ring is articulated up or down along vertical axis 714. The inclusion of two wheels provides for additional stabilization during articulation. Again, while illustrated as including a single power ring 704/control ring 702 pair, it is readily appreciated that two (or more) power ring/control ring pairs could readily be utilized depending upon the VSTOL apparatus (e.g., VSTOL apparatus 100, 200, or 300) chosen.

Referring now to FIG. 8, yet another variant of an articulation/rotation system 800 is shown and described in detail. Unlike previous embodiment illustrated, the articulation/rotation system shown includes two power rings 802a, 802b disposed external and internal of a corresponding control ring 804. The airfoil 810 is coupled to outer 802a (and optionally inner 802b) control ring via power rod 806. Power rod is further configured to rotate within the power ring(s) via a ball bearing (not shown). Moreover, control rod 808 is coupled to control ring 804 via a similar ball bearing (not shown). As the power rings and control ring rotates in unison, power ring wheels 816 run along a top surface of respective ones of the power rings 802a, 802b. Articulation rod 812 is configured to be rotated upwardly and downwardly via actuation of the actuation arm 814. As a result, control ring wheel 820, disposed along control ring arm 818, raises or depresses control ring 804 depending upon the articulation desired, thereby articulating the airfoils 810.

### Exemplary VSTOL Apparatus Maneuvering Capabilities—

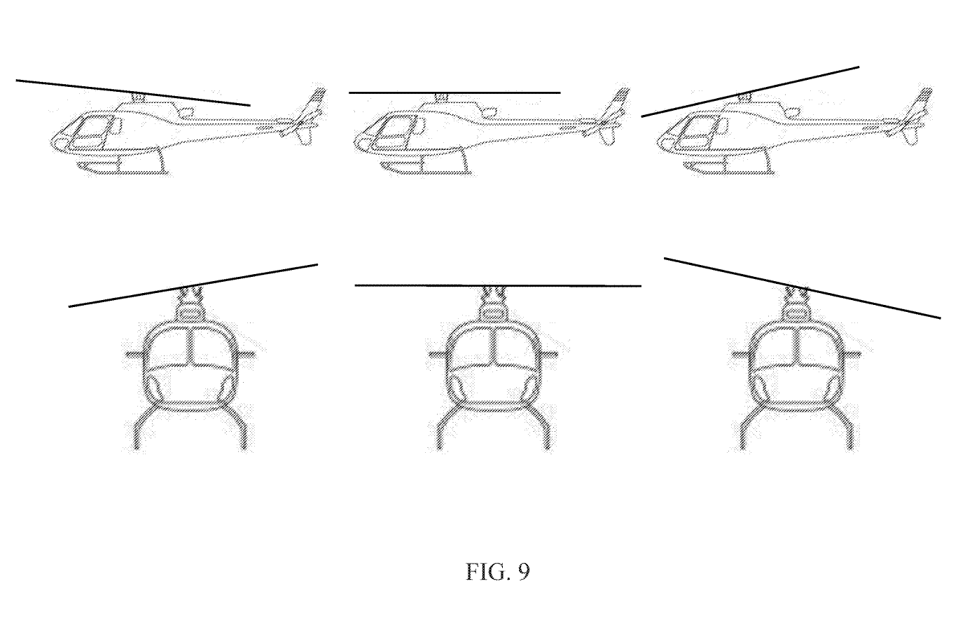

Referring now to FIG. 9, various views illustrating the maneuvering capabilities of, for example, the VSTOL apparatus of FIGS. 1-3 by virtue of its inclusion of separately rotatable fuselage assemblies are shown. While FIG. 9 illustrates various maneuvering capabilities of known rotary (helicopter) aircraft, these views are merely intended to illustrate the capabilities of the VSTOL apparatus disclosed herein. For example, the VSTOL apparatus shown with regards to FIGS. 1-3 are capable of hovering as well as forward and backward flight. Additionally, the VSTOL apparatus disclosed herein are further capable of left sideward as well as right sideward flight. Additionally, the VSTOL apparatus disclosed herein are further capable of combinations of the foregoing including, for example, forward and left sideward flight; forward and right sideward flight; backward and left sideward flight; and backward and right sideward flight. These and other operating characteristics will be readily understood by one or ordinary skill given the contents of the present disclosure.

It will be recognized that while certain aspects of the disclosure are described in terms of a specific sequence of steps of a method, these descriptions are only illustrative of the broader methods described herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features as applied to various embodiments, it will be understood that various omissions, substitutions, and changes in the form and details of the device or process illustrated may be made by those skilled in the art. The foregoing description is of the best mode presently contemplated of carrying out the principles and architectures described herein. This description is in no way meant to be limiting, but rather should be taken as illustrative of the general principles of the disclosure. The scope of the invention should be determined with reference to the claims.

What is claimed is:

1. A vertical short takeoff and landing (VSTOL) apparatus, comprising:
a fuselage;
a fuselage ring coupled at two or more connection points with the fuselage;
a plurality of airfoils;
a power ring coupled to respective ones of the plurality of airfoils; and
a control ring that is communicatively coupled with respective ones of the plurality of airfoils;
wherein the fuselage is configured to rotate with respect to the fuselage ring.

2. The VSTOL apparatus of claim 1, wherein the two or more connection points consist of two connection points.

3. The VSTOL apparatus of claim 2, wherein the two connection points are configured to enable the fuselage to independently rotate with respect to the fuselage ring, the power ring and the control ring.

4. The VSTOL apparatus of claim 1, wherein the two or more connection points comprise two or more dynamic connections with the fuselage, the two or more dynamic connections configured to enable out-of-plane movement of the fuselage with respect to the fuselage ring.

5. The VSTOL apparatus of claim 1, further comprising a tether apparatus coupled to the fuselage, the tether apparatus configured to enable one or more of a power source for the VSTOL apparatus, a communications payload for the VSTOL apparatus and VSTOL operators for the VSTOL apparatus to be located remote from the fuselage.

6. The VSTOL apparatus of claim 1, wherein the power ring comprises a plurality of undulations, the plurality of undulations configured to be driven by one or more gear sprockets.

7. The VSTOL apparatus of claim 6, further comprising an additional power ring that also comprises a plurality of additional undulations.

8. The VSTOL apparatus of claim 7, wherein a single gear sprocket is configured to drive both the power ring and the additional power ring in a substantially counter-rotating fashion.

9. The VSTOL apparatus of claim 1, further comprising an articulation system, the articulation system comprising:
an articulation cam comprising a power rod configured to couple with the power ring and a control rod configured to couple with the control ring; and
a guide slot resident within the control ring, the control rod configured to traverse the guide slot;
wherein the articulation cam is configured to rotate with respect to the power rod, the rotation of the articulation cam configured to articulate the control ring with respect to the power ring.

10. The VSTOL apparatus of claim 1, wherein the power ring comprises a pair of power rings and the control ring comprises a pair of control rings and the VSTOL apparatus further comprises an articulation system, the articulation system comprising:
a control arm that is sandwiched between a pair of control wheels; and
a groove is positioned within each of the pair of control rings, respective ones of the pair of control wheels positioned within respective ones of the control ring grooves;
wherein a separation of the pair of control wheels with respect to one another is configured to articulate respective ones of the pair of control rings.

11. The VSTOL apparatus of claim 1, wherein the power ring is configured to rotate with respect to the control ring and the VSTOL apparatus further comprises an articulation system, the articulation system comprising:
a power rod that couples an airfoil to the power ring;
a control cam arm that is coupled with the airfoil and a swivel wheel mount; and
a control ring guide located on the control ring, the control ring guide configured to receive the swivel wheel mount;
wherein an articulation of the control ring is configured to articulate the airfoil via the control cam arm.

12. The VSTOL apparatus of claim 1, wherein the power ring is configured to rotate with respect to the control ring and the VSTOL apparatus further comprises an articulation system, the articulation system comprising:
a single control cam arm comprised of a swivel wheel mount, the single control cam arm configured to be coupled with an airfoil, the single control cam arm further configured to be received within the power ring via a bearing;
wherein an articulation of the control ring is configured to articulate the airfoil via the single control cam arm.

13. The VSTOL apparatus of claim 12, wherein the swivel wheel mount comprises at least two wheels, the at least two wheels providing for additional stabilization during articulation.

14. The VSTOL apparatus of claim 1, wherein the power ring comprises a pair of power rings and the VSTOL apparatus further comprises an articulation system, the articulation system comprising:
an articulation rod coupled to a pair of power ring wheels, each of the power ring wheels of the pair configured to interface with a respective power ring of the pair at a top surface thereof; and
a control ring arm that is coupled to a control ring wheel, the control ring arm disposed between the pair of power ring wheels, the control ring wheel configured to interface with the control ring at a top surface thereof;
wherein articulation of the articulation rod is configured to articulate the control ring with respect to the pair of power rings thereby articulating one or more of the plurality of airfoils.
